(19) United States
(12) Patent Application Publication
(10) Pub. No.: US 2006/0059514 A1
(43) Pub. Date: Mar. 16, 2006

(54) Method and apparatus for utilizing blank space on a high definition television screen

(76) Inventors: Eric Hsiao, Carlsbad, CA (US); Kim Annon Ryal, Mason, MI (US)

Correspondence Address: WAGNER, MURABITO & HAO LLP, Third Floor, Two North Market Street, San Jose, CA, 95113, US

(21) Appl. No.: 10/938,115

(22) Filed: Sep. 10, 2004

(51) Int. Cl. H04N 5/445; H04N 7/173; G06F 13/00

(52) U.S. Cl. 725/42; 348/563; 725/39; 725/109; 725/110; 725/43

(57) ABSTRACT

A method and system for displaying media in the otherwise blank spaces remaining when a standard television signal is viewed on a high definition television screen and vice versa. In one embodiment, two separate media are accessed by a set top box for a high definition television screen. A standard television broadcasting signal is accessed as well as second media signal. The second media signal may consist of for example advertisements, program guide information, an internet browser, other media, etc. The standard television signal is rendered on a main portion of the high definition television screen, while the second media occupies the remaining space.

### BACKGROUND OF THE INVENTION

1. Field of the Invention

The present invention relates to the field of television display. More specifically, embodiments of the present invention pertain to a method and apparatus for utilizing the blank space that results from displaying a standard definition television signal on a high definition television screen and vice versa.

2. Related Art

High Definition Television (HDTV) is a system for transmitting a television signal with far greater resolution and a wider aspect ratio than a standard television signal. An HDTV screen offers two million pixels, compared to the half million or so pixels on a standard television screen. An HDTV also doubles the standard 525 lines which make up a standard television image. HDTV screens and signals have a 16:9 aspect ratio, as opposed to the 4:3 aspect ratio offered by standard television. A 16:9 aspect ratio is closer to aspect ratio found in a movie theater. Since the advent of HDTV, there has been an increasing demand for high definition television sets.

Today, many television stations are broadcasting programs in HDTV format, as well as standard format. Many videos and DVDs for home viewing offer both a standard 4:3 aspect ratio, or “full screen” format, and a 16:9, or “wide screen” version. Today, television sets and broadcasting companies generally are capable of handling both standard and HDTV signals.

Consumers are drawn to the wider aspect ratio of HDTV sets, which makes better use of the human visual field and recreates the movie theater experience. Consumers are also drawn to the clarity and sharpness of the digital display of HDTV. High definition televisions are capable of receiving and displaying standard television signals. In order to receive HDTV signals on either a high definition or a standard television, consumers need a set top box designed for this purpose.

As shown in FIG. 1, when a standard television signal is received by a high definition TV 110, the display 102 can be centered on the screen with vertical black strips down the left 101 and right hand 103 sides. Alternatively, the standard display can be stretched horizontally to fit the high definition screen, but this method warps the image. Also, the image could be cropped to fit within the screen, but this method prevents the viewer from seeing the entire intended image.

FIG. 2 depicts the display 202 of an HDTV signal on a standard TV screen 210. In this configuration, the image 202 is centered in the middle of the screen with horizontal black strips running along the top 201 and the bottom 203 of the display screen. This configuration is called “letterbox.” Alternatively, the high definition image can be stretched vertically to fit the standard screen, but this method warps the image. The high definition image can also be cropped to fit the standard screen, thus eliminating part of the intended image. As stretching and cropping lead to undesirable effects in both scenarios, the black bars have become an accepted nuisance and eventually viewers fail to notice them.

### SUMMARY OF THE INVENTION

A method and system are disclosed for making use of the otherwise unused regions, e.g. black bars that are displayed when a standard television signal is shown on a high definition television and vice versa. Instead of blackness or other non-display regions of the display screen, the space is advantageously filled with media independent from the standard programming according to embodiments of the present invention. Forms of media that can be used for this purpose for example include advertisements, programming guide information, interactive television applications and/or an internet browser. This additional media and/or information is displayed simultaneously with the content of the program also being displayed. A set top box is disclosed that is capable of receiving and conveying two signals, one of which is the standard television signal, and the other of which is this other media. The set top box is capable of displaying the standard signal in the center of the screen with other media along the right and left side, of displaying the standard signal on the right with other media along the left, or of displaying the standard signal on the left with other media along the right side of the high definition display screen. In another embodiment of the present invention, a set top box for a standard television receives, conveys and renders a high definition television signal on the display screen and additional media and/or information in the region(s) not occupied by the high definition television image.

### BRIEF DESCRIPTION OF THE DRAWINGS

The accompanying drawings, which are incorporated in and form a part of this specification, illustrate embodiments of the invention and, together with the description, serve to explain the principles of the invention:

Prior Art FIG. 1 depicts the conventional display of a standard signal on an HDTV screen.

Prior Art FIG. 2 depicts the conventional display of a high definition signal on a standard television screen.

FIG. 3A illustrates a standard TV signal broadcast on an HDTV with other media along the right and left hand sides.

FIG. 3B illustrates a standard TV signal broadcast on the left hand side of an HDTV display screen with other media displayed along the right side.

FIG. 3C illustrates a standard TV signal broadcast on the right hand side of an HDTV display screen with other media displayed along the left side.

FIG. 4A depicts a high definition signal broadcast on a standard television with other media along the top and bottom of the display screen.

FIG. 4B depicts a high definition signal broadcast in the top of the display screen of a standard TV, with other media along the bottom.

FIG. 4C depicts a high definition signal broadcast in the bottom of the display screen of a standard TV, with other media along the top.

FIG. 5 is a flowchart illustrating a method for accessing a standard definition signal, as well as another media signal, and displaying both on an HDTV.

FIG. 6 is a block diagram depicting a system for displaying a standard TV program on an HDTV with media in the leftover space along the right and left hand sides.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. To the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be clear to one of ordinary skill in the art that the present invention may be practiced without these specific details. In other instances, well known methods, procedures, components, and circuits have not been described in detail as not to unnecessarily obscure aspects of the present invention.

Utilizing conventional methods and set top boxes, consumers viewing standard TV broadcasts or full screen format home movies on a high definition 16:9 television also view the obligatory black strips, e.g. non-display regions along the left and right sides of the display screen. Thus, as much as one quarter of the screen is left to waste. Conversely, consumers viewing high definition broadcasts or other wide screen format home movies on a standard 4:3 television are forced to accept the black bars running along the top and bottom of the screen, and as much as one quarter of the screen is left to waste again.

FIG. 3A illustrates one embodiment of the present invention. A standard television signal is received by a high definition television 310. The image 302 carried by the standard signal is displayed in the center of the high definition screen, in its original 4:3 aspect ratio. Other, e.g. auxiliary media is displayed in the vertical strips along the left 301 and the right 302 sides of the screen 310. Referring now to FIG. 3B, an alternative embodiment of the present invention is to shift the standard TV image 302 to the left and use the leftover space on the right hand side 304 for other media. Another alternative, depicted in FIG. 3C, is to shift the standard TV image 302 to the right and display other media in the space 305 left on the left-hand side of the display screen 310.

The auxiliary information that is displayed within regions 301, 303, 304, and 305 may be any information related to the program or unrelated to the program being shown on the display screen. For instance, these regions may display advertisements, on-screen program guides, interactive television applications (running in conjunction with a game show for example), internet browser information, etc. Whether related to the program or not, the auxiliary information generally arrives on a signal or signal portion separate from the data comprising the program.

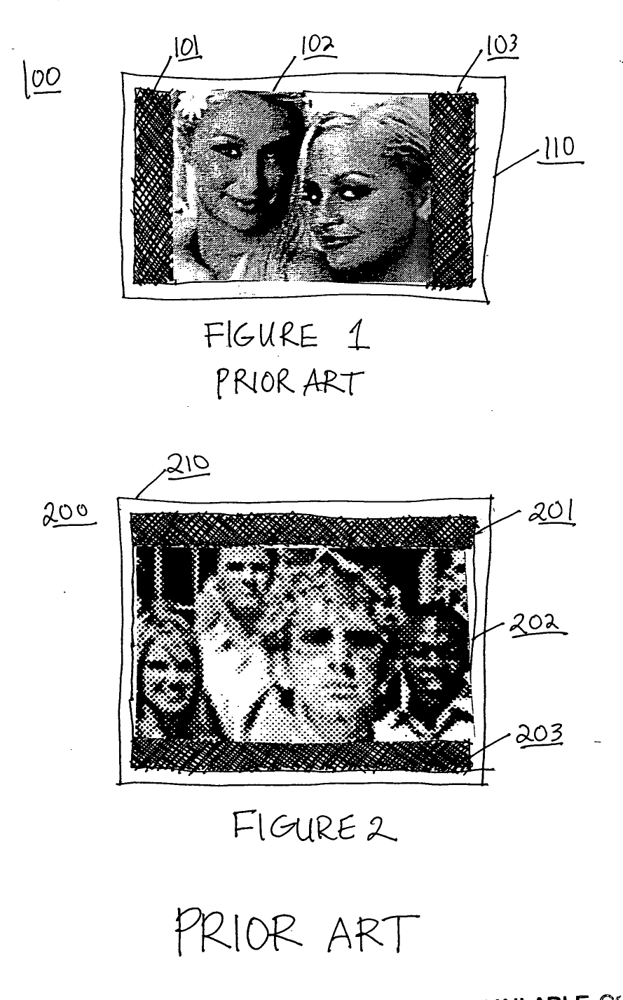

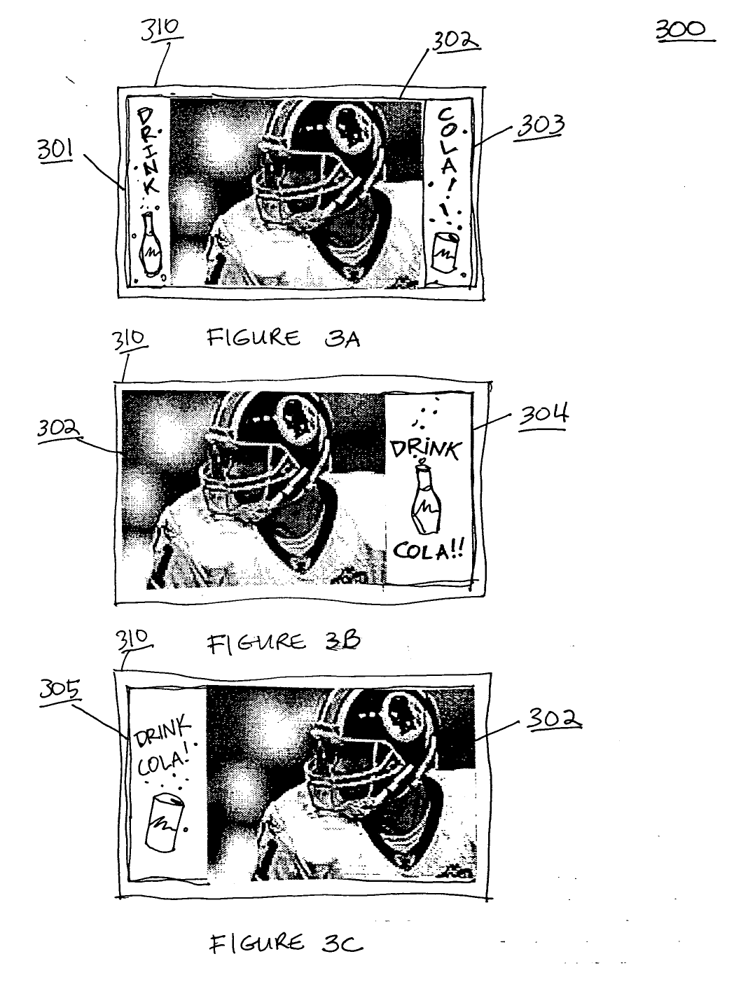

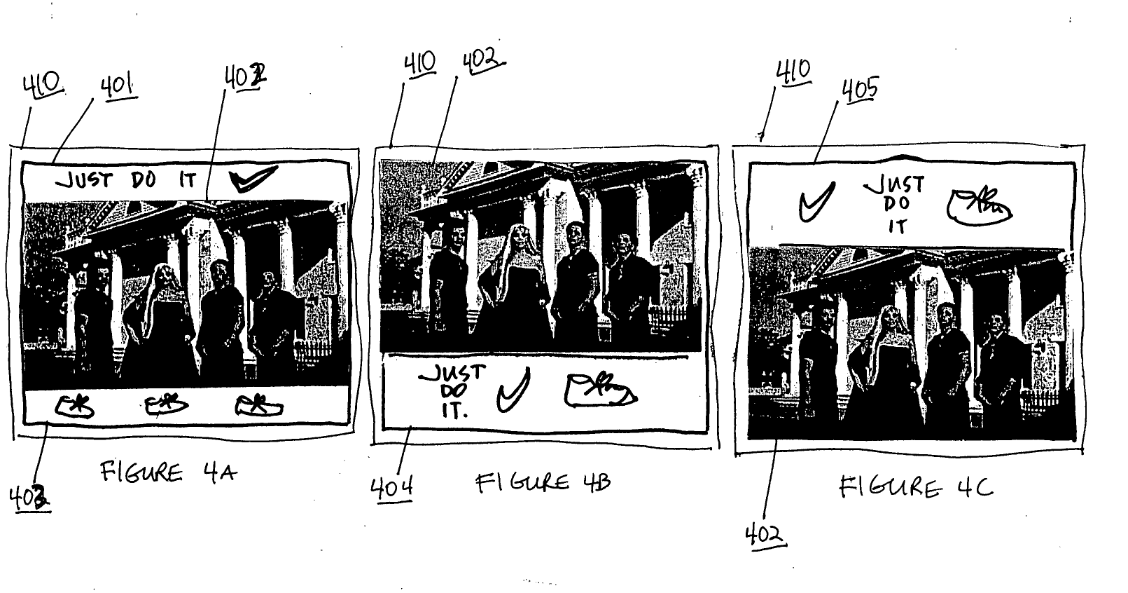

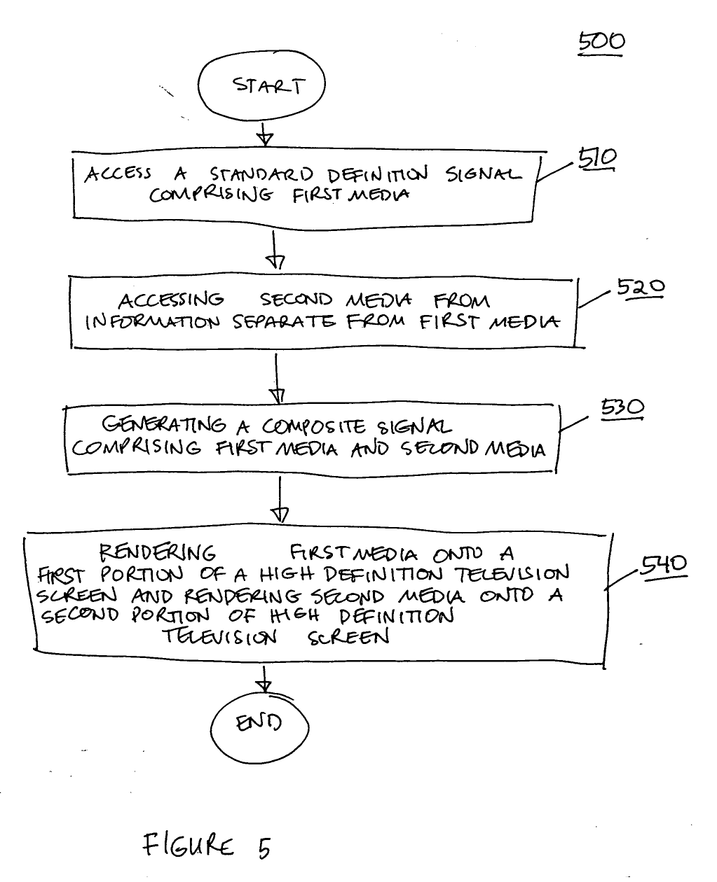

Another embodiment of the present invention consists of displaying a high definition signal broadcast on a standard television screen. FIG. 4A illustrates the high definition image 402 in the middle of a standard screen 410. Other media is displayed in the left over spaces along the top 401 and the bottom 403. Referring now to FIG. 4B, the standard signal image 402 can be shifted to the top of the screen 410, with the left over space along the bottom 404 filled with other media. Alternatively, the standard signal image 402 can be shifted to the bottom of the standard screen 410, leaving a top portion 405 to be occupied by other media, as depicted in FIG. 4C.

As discussed above, the other media used to fill the empty space can consist of advertisements, programming guide information, an internet browser, interactive television applications, or any other sort of media capable of being displayed on a television screen and conveyed by television broadcasting signals. In a preferred embodiment of the present invention, the other media may be sent by service provider, e.g. a cable company during the video blanking interval of the regular broadcasting signal. The video blanking interval is essentially a segment of the broadcast frequency not used to produce the standard display. The blanking interval in sending a video signal is the period of time it takes the electron gun in a television monitor's cathode ray tube to fly back up to the top of the tube.

Alternatively, the source of this auxiliary information could originate from a separate stream of a broadcast channel. Also, the source could originate from within an embedded or connected computer system, e.g. operating an internet browser application.

In one embodiment of the present invention, the set top box uses a built-in graphics engine to create a separate video surface plane in the unused black section(s) of the display screen. For example, the set top box devotes one video surface plane to a standard definition television signal, and a separate video plane for auxiliary media. The graphics engine within the set top box utilizes a graphics overlay function in a manner similar to that employed by a PC.

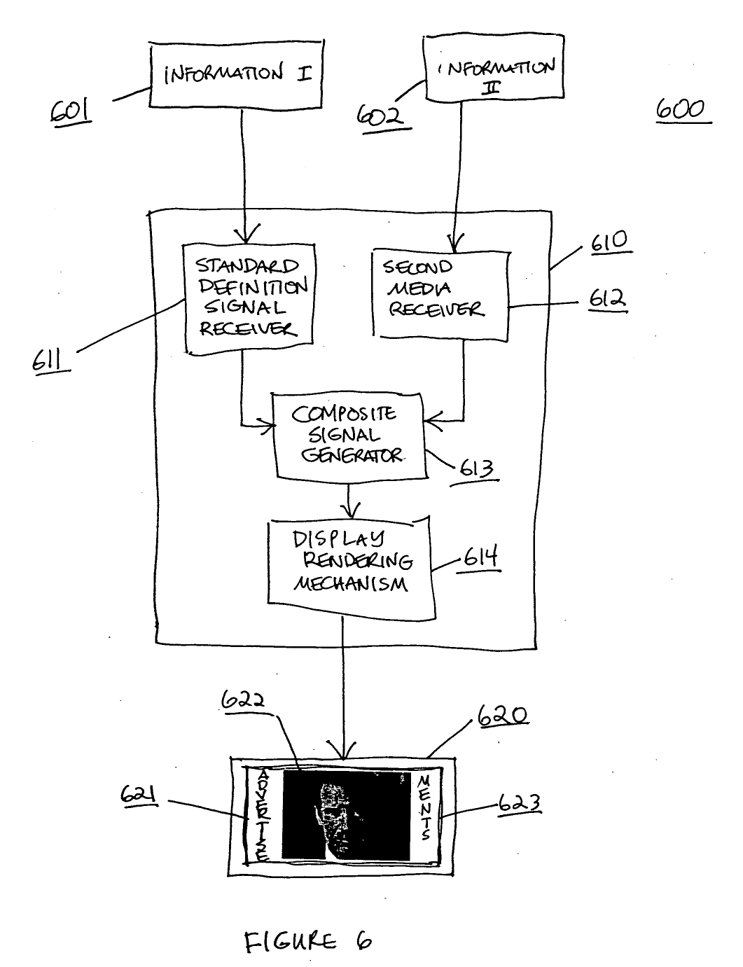

FIG. 5 is a flowchart 500 illustrating a method employed to fill the portions of a high definition television screen unused by a standard television image. At step 510, a standard definition television signal is accessed. The standard definition signal contains standard formatted first media. In a preferred embodiment this first media is defined by an aspect ratio of 4:3, which is a standard television aspect ratio. The first media referred to in step 510 may be defined by other aspect ratios in other embodiments. Step 520 of FIG. 5 is accessing second or auxiliary media from information separate from the first media. In a preferred embodiment, the second media consists of advertisement or other information, as depicted and described with reference to FIGS. 3A-3C and FIGS. 4A-4C. In another embodiment, the second media consists of program guide information. For example, the second media could display upcoming program information, including storylines, show times, the names of actors and actresses, etc. In another embodiment, the second media referred to in step 520 is an internet browser. The second media may or may not be related to the first media. In one embodiment the body of information from which the first media originates is completely separate from the body of information from which the second media comes.

Step 530 in the method 500 is generating a composite signal comprising the first and second media. In one embodiment, this composite signal is generated within the set top box. In another embodiment, this composite signal is generated by a broadcasting company, and the second media is sent during the video blanking interval of the regular broadcasting frequency. Depending on user selection, or default setting, the composite signal places the auxiliary media either on the left and right of the standard definition image, or on the left only or on the right only. In the last two cases, the standard definition image is pushed to the right or to the left, respectively.

In step 540, the first media is rendered onto a first portion of a high definition television screen and the second media is rendered onto a second portion of a high definition television screen. As illustrated in an embodiment of the present invention illustrated in FIG. 3A, the first media is displayed on a first portion 302 in the center of the HD screen 310, and the second media is displayed on a second portion, and the second portion consists of strips along the left 301 and the right 303 sides of the screen. FIG. 3B depicts an embodiment where the first portion 302 occupies the left hand side of the screen, and the second portion 304 is situated on the right hand side. Alternatively, as illustrated in FIG. 3C, the first portion 302 is located on the right hand side of the screen, while the second portion 305 is on the left hand side.

Another embodiment of the present invention, depicted in FIGS. 4A-4C, is a method having the steps of accessing a high definition television signal comprising first media and accessing second media from information separate from first media. A composite signal is then generated comprising the first and second-media. The first media is then rendered onto a first portion of a standard television screen and the second media is rendered onto a second portion of a standard television screen. In the embodiment depicted in FIGS. 4A-4C, the first media has an aspect ratio of 16:9, which is the basic aspect ratio of high definition television. In other embodiments, the first media has a different aspect ratio.

FIG. 6 illustrates a system 600 for accomplishing one embodiment of the present invention. System 600 includes a set top box 610. The set top box 610 contains a standard definition signal receiver 611 for accessing a standard definition signal comprising first media from body of information I 601. Set top box 610 also contains a second media receiver 612 for accessing second media from body of information II 602, which is separate from body of information I 601. Set top box 610 further includes a composite signal generator 613 for combining the two signals received by the standard definition signal receiver 611 and the second media receiver 612. In another embodiment of the present invention, the signals are combined by a television or cable broadcasting company. The second media can be sent from a cable company during the video blanking interval of the standard definition broadcasting signal. Set top box 610 also includes a display rendering mechanism 614 for rendering the first media onto a first portion 622 of a high definition television screen 620 and the second media onto a second portion 621 and 623 of a high definition television screen 620. Other possible display scenarios are illustrated in FIGS. 3A-3C. Body of information II 602 can originate from an embedded or connected computer running a browser application.

In another embodiment of the present invention, television screen 620 is a standard television screen, and signal receiver 611 accesses high definition television signals. In this scenario, the display on television screen 620 would resemble the television screen 410 depicted in FIGS. 4A-4C.

Set top box 610 of FIG. 6 is capable of rendering both standard and high definition broadcasting signals on a high definition television. In a preferred embodiment, the second media displayed in the second portion of the display screen 620 consists of advertisements. In another embodiment, the second media is program guide information. In a third embodiment, the second media is a web browser. The second media could be any media which can be formatted to be received by a set top box and/or displayed on a standard or high definition television screen. In one embodiment of the present invention, set top box 610 also includes a user-control whereby a user can control whether or not the second media is displayed. In one embodiment, a user can also control whether or not the standard television image will be displayed in the center of the screen (FIG. 3A), on the left (FIG. 3B), or on the right side (FIG. 3C) of the display screen.

Although certain embodiments of the present invention as described herein pertains primarily to displaying 4:3 aspect ratio media on a 16:9 aspect ratio display screen and displaying other media in the remaining space, it is appreciated that many other advantageous applications are possible within the scope of the present invention. For example, the present invention can be advantageously applied to displaying 16:9 aspect ratio media on a 4:3 aspect ratio display screen and displaying other media in the remaining space. It should be clear to a person of ordinary skill in the art, having read the description of embodiments of the present invention herein, that other applications and embodiments not expressly described herein are also possible without departing from the scope and spirit of the present invention.

The preferred embodiment of the present invention, a method and system for utilizing blank space on a high definition television screen, are thus described. While the present invention has been described in particular embodiments, it should be appreciated that the present invention should not be construed as limited by such embodiments, but rather construed according to the below claims.

What is claimed is:

1. A method of displaying onto a television comprising:
accessing a standard definition signal comprising first media;
accessing second media from information separate from said first media;
generating a composite signal comprising said first media and said second media; and
based on said composite signal, rendering said first media onto a first portion of a high definition television screen and rendering said second media onto a second portion of said high definition television screen, wherein said second portion is not required for display of said first media and is left blank in absence of said second media.

2. A method as described in claim 1 wherein said second media comprises program guide information.

3. A method as described in claim 1 wherein said second media comprises a web browser.

4. A method as described in claim 1 wherein said second media comprises advertisement content.

5. A method as described in claim 1 wherein said first portion is a left portion of said high definition television screen and wherein said second portion is a right portion of said high definition television screen.

6. A method as described in claim 1 wherein said first portion is a right portion of said high definition television screen and wherein said second portion is a left portion of said high definition television screen.

7. A method as described in claim 1 wherein said first portion is a middle portion of said high definition television screen and wherein said second portion is a left and right portion of said high definition television screen.

8. A method as described in claim 1 wherein said standard definition signal is substantially compliant with a 4:3 aspect ratio display format and wherein said high definition television screen is substantially compliant with a 16:9 aspect ratio display format.

9. A method as described in claim 1 wherein said generating said composite signal comprises combining a first video surface plane related to said first media and a second video surface plane related to said second media.

10. A method as described in claim 1 wherein said second media is received during a video blanking interval of said standard definition signal.

11. A set top box for a displaying onto a television comprising:
means for receiving a first standard definition signal comprising first media;
means for receiving a second media from information separate from said first media; and
means for generating a composite signal comprising said first media and said second media; wherein said first media is to be rendered onto a first portion of a high definition television screen and said second media is to be rendered onto a second portion of said high definition television screen, wherein said second portion is left blank in absence of said second media.

12. A set top box as described in claim 11 wherein said second media comprises program guide information.

13. A set top box as described in claim 11 wherein said second media comprises a web browser.

14. A set top box as described in claim 11 wherein said second media comprises advertisement content.

15. A set top box as described in claim 11 wherein said first portion is a left portion of said high definition television screen and wherein said second portion is a right portion of said high definition television screen.

16. A set top box as described in claim 11 wherein said first portion is a right portion of said high definition television screen and wherein said second portion is a left portion of said high television screen.

17. A set top box as described in claim 11 wherein said first portion is a middle portion of said high definition television screen and wherein said second portion is a left and right portion of said high definition television screen.

18. A set top box as described in claim 11 wherein said standard definition signal is substantially compliant with a 4:3 aspect ratio display format and wherein said high definition signal is substantially compliant with a 16:9 aspect ration display format.

19. A set top box as described in claim 11 wherein said generating said composite signal comprises combining a first video surface plane related to said first media and a second video surface plane related to said second media.

20. A set top box as described in claim 11 wherein said second media is received during a video blanking interval of said standard definition signal.

21. A method of displaying onto a television comprising:
accessing a high definition definition signal comprising first media;
accessing second media from information separate from said first media;
generating a composite signal comprising said first media and said second media; and
based on said composite signal, rendering said first media onto a first portion of a standard television screen and rendering said second media onto a second portion of said standard television screen, wherein said second portion is not required for display of said first media and is left blank in absence of said second media.

22. A method as described in claim 21 wherein said second media comprises program guide information.

23. A method as described in claim 21 wherein said second media comprises a web browser.

24. A method as described in claim 21 wherein said second media comprises advertisement content.

25. A method as described in claim 21 wherein said first portion is a top portion of said standard television screen and wherein said second portion is a bottom portion of said standard television screen.

26. A method as described in claim 21 wherein said first portion is a bottom portion of said standard television screen and wherein said second portion is a top portion of said standard television screen.

27. A method as described in claim 21 wherein said first portion is a middle portion of said standard television screen and wherein said second portion is a top and bottom portion of said standard television screen.

28. A method as described in claim 21 wherein said high-definition television signal is substantially compliant with a 16:9 aspect ratio display format and wherein said standard definition television screen is substantially compliant with a 4:3 aspect ratio display format.
